(19) United States
(12) Patent Application Publication
(10) Pub. No.: US 2014/0342597 A1
(43) Pub. Date: Nov. 20, 2014

(54) COMPLIANT MULTI-CONNECTOR BLOCK DEVICE

(71) Applicant: Teleplan International NV, Schiphol (NL)

(72) Inventor: Glenn Albert, Longmont, CO (US)

(73) Assignee: Telephan International NV, Schiphol (NL)

(21) Appl. No.: 13/896,753

(22) Filed: May 17, 2013

(51) Int. Cl. H01R 13/629

(52) U.S. Cl. CPC H01R 13/629
USPC 439/476.1

(57) ABSTRACT

A multi-connector block device for retaining A/V cable plugs for easier insertion and removal from corresponding ports in electronic devices. The device may include a body portion with a cable end and a plug end. The cable end preferably has a cable hole therein, although the cable end may have individual holes for each A/V cable to be retained by the device. The plug end preferably has at least two plug holes therein. The body portion has a hollow which extends from the cable hole to the plug holes. The device also includes at least two plug-retaining sections formed by the hollow. The plug-retaining sections are each sized and shaped to retain an A/V cable plug, such that a connector prong of the plug extends from the corresponding plug hole of the body when the plug is retained by the corresponding plug-retaining section.

### CROSS-REFERENCE TO RELATED APPLICATIONS

None.

### BACKGROUND OF THE INVENTION

Electronic products, such as televisions, DVD and other disc players, cable/satellite set-top boxes, audio equipment, etc., often include many physical input and output ports. In the case of a set-top box for cable or satellite, there can be upwards of 15 or more separate ports. As anyone who has ever installed equipment in a home entertainment system can attest, plugging in each separate plug into the correct port can be very difficult and time consuming. The multitude of ports, plugs, wires, and colors can be confusing, and are often difficult to work with. For home installation, these issues often become a headache.

For example, common ports on home video equipment are the Component Video (RGB) output of a set-top box. Component Video consists of three separate RCA ports—red, green and blue. Plugging in three separate RCA cable plugs requires three separate operations. However, when using Component Video, no audio is transmitted. Therefore, two additional RCA cables are needed for stereo sound, and must be plugged into the corresponding ports. Thus, in this configuration, at least five ports and cables are used. Additional ports may also be used.

This leads to additional problems for the original manufacturer and after-market services centers, which are responsible for screening, testing, repairing and/or refurbishing such products. For these companies, large volumes of equipment are continuously tested, requiring various cables and plugs to be plugged into and unplugged from ports as needed. Each plug/port requires a certain amount of time for an operator to attach/detach the respective cables. The need to individually plug in numerous plugs and cables is time consuming, and slows the testing process. Indeed, the time required to attach and detach cables connecting the device-under-test to the test equipment can be a significant portion of the overall test process time.

### SUMMARY OF THE INVENTION

The present invention relates to embodiments of a multi-connector block device for retaining audio/visual (A/V) cable plugs for easier insertion and removal from corresponding ports in electronic devices. In one embodiment, the device includes a body portion with a cable end and a plug end. The cable end preferably has a cable hole therein, although the cable end may have individual holes for each A/V cable to be retained by the device. The plug end preferably has at least two plug holes therein—one for each A/V cable plug to be retained by the device. The body portion has a hollow which extends from the (at least one) cable hole to the plug holes. The device also includes at least two plug-retaining sections formed by the hollow. The plug-retaining sections are each sized and shaped to retain an A/V cable plug, such that a connector prong of the plug extends from the corresponding plug hole of the body when the plug is retained by the corresponding plug-retaining section. When an A/V cable plug is retained within a plug-retaining section, the A/V cable extends back through the hollow and out the (at least one) cable hole of the body portion.

The body portion may be comprised of material which is flexible and deforms substantially elastically, such as urethane rubber or silicone rubber. Such an embodiment preferably has a hardness of between about 40 and 80 Shore A, and more preferably between about 60 and 80 Shore A. This flexibility may allow an A/V cable plug to be inserted and withdrawn from a plug-retaining section. Alternatively, the device may be comprised of material which is relatively rigid.

Where the body portion is flexible, the material which makes up the body portion preferably isolates each plug-retaining section from an adjacent plug-retaining section near the plug end of the body portion. Preferably, a gap is present through the material of the body portion between adjacent plug-retaining sections. This allows for increased flexibility of the body portion between the plug-retaining sections, so as to allow A/V cable plugs housed within the respective plug-retaining sections to deflect laterally by about 1 to 2-mm. Alternatively, where the body portion is relatively rigid, the plug-retaining sections are preferably sized and shaped to retain an A/V cable plug loosely therein, such that an A/V cable plug may move laterally within the plug-retaining section by about 1 to 2-mm. This helps to account for slight variations in port spacing on devices. In such an embodiment, the device may be over-molded around the A/V cable plugs to secure same permanently within the body portion.

The body portion preferably also includes at least one indentation toward the cable end of the body portion, and the body portion may be substantially transparent.

### BRIEF DESCRIPTION OF THE DRAWINGS

FIG. 1 is a perspective view of a typical panel of input/output ports on an example prior art electronic device.

FIG. 2 is a perspective view of prior art red, green and blue RCA cables being plugged into the Component Video ports of the electronic device of FIG. 1.

FIG. 3 is a perspective view of six typical RCA cables plugged into the electronic device of FIG. 1, including three Component Video cables, two audio cables and a standard video cable.

FIG. 4A is a top plan view of a multi-connector block device according to an embodiment of the present invention, in which three RCA cables—red, green and blue—are visible within the device.

FIG. 4B is a top plan view of a multi-connector block device according to an alternative embodiment of the present invention, in which two RCA cables—red and white—are visible within the device.

FIG. 5A is a cross sectional view across line 5A in FIG. 4A, showing three separate plug-retaining sections containing three separate RCA cable plugs.

FIG. 5B is a cross sectional view across line 5B in FIG. 4A, showing three RCA cable plugs housed within the body portion of the device.

FIG. 6A is a perspective view of three RCA cables housed within the first embodiment of the device being inserted together into the Component Video ports from FIG. 1.

FIG. 6B is a perspective view of three RCA cables housed within the first device having being inserted together into the Component Video ports from FIG. 1, while a two RCA cables housed within the second embodiment of the device being inserted together into the Audio Input ports from FIG. 1.

FIG. 6C is a perspective view of all six RCA cables plugged into the electronic device, with three cables housed within the first device and another two RCA cables housed within the second embodiment of the device.

FIG. 7A is a perspective view of the first embodiment of the device holding three RCA cables being prepared for engagement with a different electrical device having a different port arrangement which does not exactly align with the plugs held within the device.

FIG. 7B is a perspective view of the device from FIG. 7A in which the device has flexed to allow the RCA cables to be successfully plugged into the differently arranged and spaced input ports of FIG. 7A.

FIG. 8 is a perspective view of all six RCA cables plugged into the electronic device of FIG. 7A, with three cables housed within the first device and another two RCA cables housed within the second embodiment of the device.

While the disclosure is susceptible to various modifications and alternative forms, specific embodiments thereof are shown by way of example in the drawing and will herein be described in detail. It should be understood, however, that the drawings and detailed description presented herein are not intended to limit the disclosure to the particular embodiment disclosed, but on the contrary, the intention is to cover all modifications, equivalents, and alternatives falling within the spirit and scope of the present disclosure as defined by the appended claims.

### DETAILED DESCRIPTION OF THE INVENTION

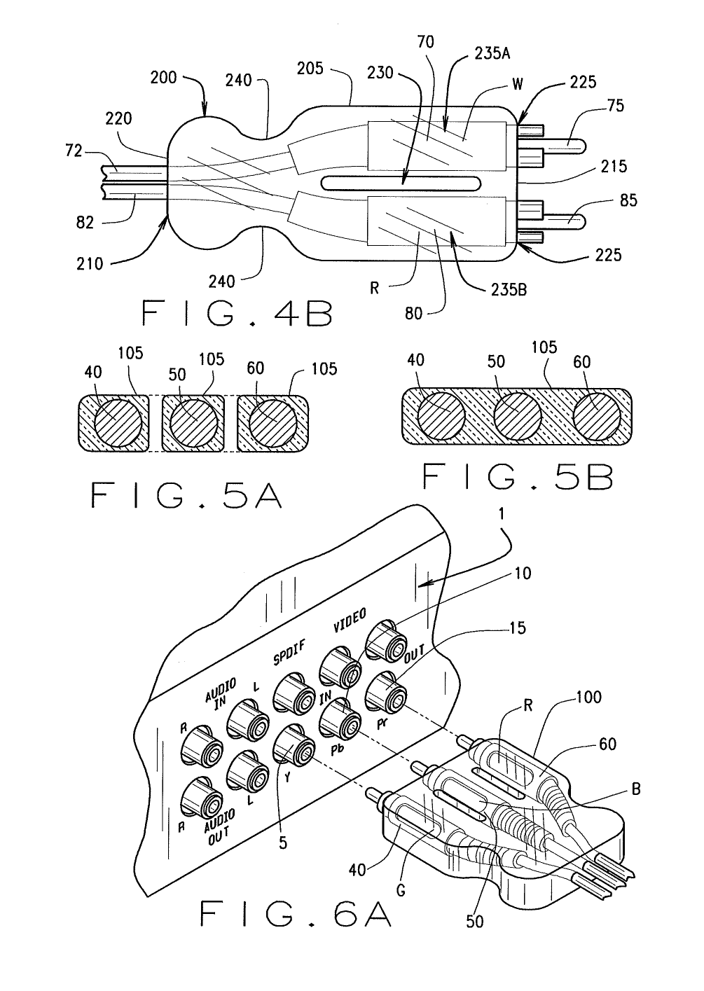

Referring to the drawings particularly by reference numbers wherein like numerals refer to like parts, FIGS. 1-3 illustrate prior art components and situations, while FIGS. 4A-8 illustrate various embodiments of a multi-connector block device. FIG. 1 illustrates an example prior art electronic device 1, and specifically the input/output (I/O) panel on such an electronic device 1. As can be seen, Component Video input ports for green 5, blue 10 and red 15 are positioned adjacent to one another. Additionally, audio out ports 20 and 25 and video out port 30 can be seen. As shown, each of these ports is an RCA cable port, although it is noted that ports and cables of any type are contemplated.

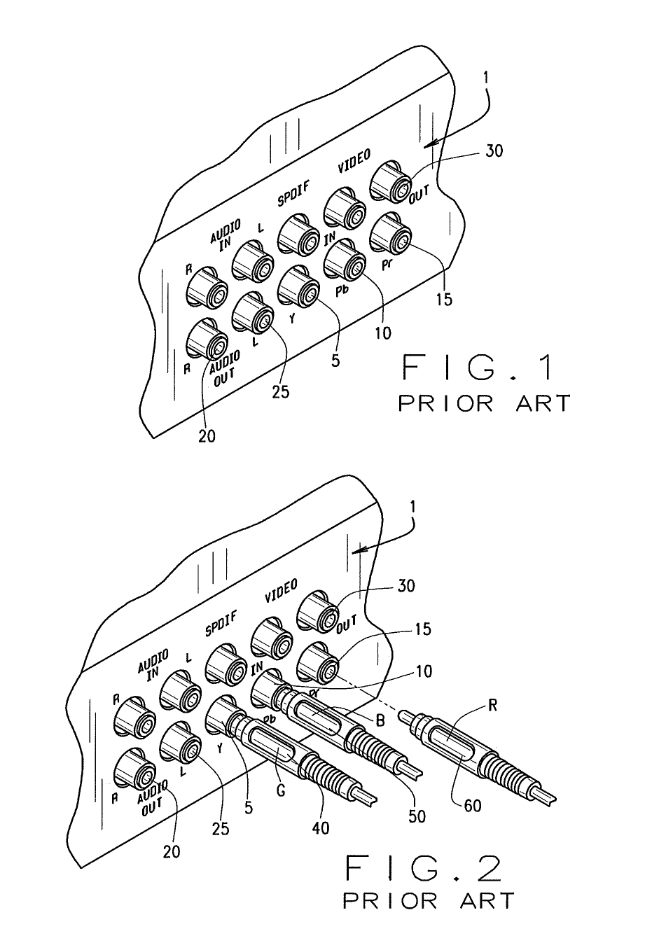

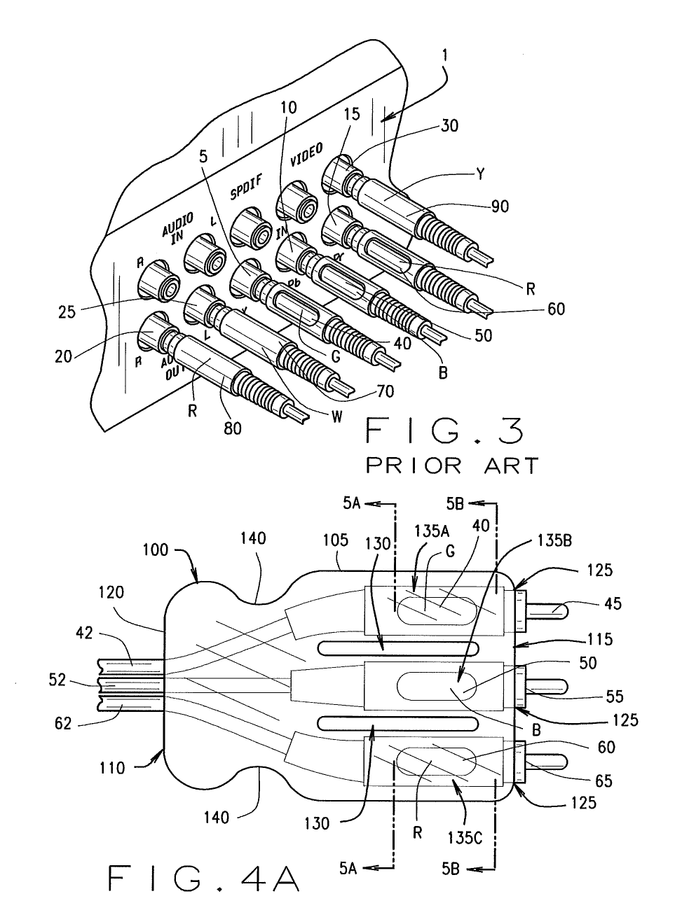

Further, as shown in FIG. 2, component RCA cables for green 40, blue 50 and red 60 are typically plugged into the respective ports 5, 10, 15 on the electronic device 1. FIG. 3 illustrates a fairly typical cable arrangement, in which three additional RCA cables are plugged into the electronic device 1: white 70 and red 80 RCA cables are plugged into the right 20 and left 25 audio output ports, while yellow 90 RCA cable is plugged into the video out port 30. Although FIG. 3 shows a somewhat orderly arrangement of plugs and wires and cables, as most people will recognize, such an set-up generally results in a tangled mess of cables and differently colored RCA plugs. Further, plugging in each cable individually can take a significant amount of time.

FIG. 4A shows a first embodiment of a multi-connector block device 100 which is designed to decrease the aforementioned clutter of cables, and to reduce the amount of time necessary to plug in and unplug the various necessary cables from typical electronic equipment. Block device 100 is preferably made from a flexible material which deforms substantially elastically. For example, urethane rubber and silicone rubber may be used, although other materials are envisioned. Such materials may also be substantially transparent. Preferably, the block device 100 is made of a material that has a hardness of between about 40 and 80 Shore A, and more preferably between about 60 and 80 Shore A.

As shown, block device 100 includes a body portion 105, and has a cable end 110 and a plug end 115. A cable hole 120 is present at the cable end 110 of body portion 105, while three plug holes 125 are present at the plug end 115 of body portion 105. Three RCA plugs 40, 50, 60 are positioned within the body portion 105 such that the pin and ring connector portion 45, 55, 65 of plugs 40, 50, 60 extend out through the three plug holes 125. Similarly, three RCA cable wires 42, 52, 62 extend out of the body portion 105 via cable hole 120. Thus, body portion 105 includes a hollow which connects the cable hole 120 with the plug holes 125. As can be seen, block device 100 may further include at least one, and preferably two opposing indentations 140 which help a user grip the block device 100 for easier insertion and removal.

Further, as can be seen, toward the plug end 115 of the body portion 105, two cutout gaps 130 are present between the three RCA cable plugs 40, 50, 60. These two gaps 130 define three separate plug-retaining sections 135A, 135B, 135C which retain the three RCA cable plugs 40, 50, 60. Preferably, and as shown in FIG. 5A which is a cross section taken across line 5A from FIG. 4A, body portion 105 extends around plugs 40, 50, 60 to fully enclose plugs 40, 50, 60 transversely within the plug-retaining sections 135A-135C. This helps plug-retaining sections 135A-135C retain the plugs 40, 50, 60 in place and properly spaced apart. Additionally, as can be seen in FIGS. 4A and 5B (which is a cross section taken across line 5B from FIG. 4A), gaps 130 may stop short of the plug end 115 of body portion 105. However, it is noted that gaps 130 may actually extend all the way to the plug end 115 of the body portion 105. Plug-retaining sections 135A-135C may tightly surround plugs 40, 50, 60, or may provide some space in which plugs 40, 50, 60 can move within the provided channels.

FIG. 4B illustrates a second embodiment of the multi-connector block device 200 which only holds two plugs 70, 80, in this case shown as white and red respectively. In this embodiment, block device 200 still includes a body portion 205 with a cable end 210 and a plug end 215. Cable end 210 still includes a cable hole 220 from which cable wires 72, 82 exit the block device 200. In this embodiment, however, plug end 215 includes only two plug holes 225. Only two RCA plugs 70, 80 are positioned within the body portion 205 such that the pin and ring connector portion 75, 85 of plugs 70, 80 extend out through the two plug holes 225. The hollow in block device 200 extends from the cable hole 220 to the two plug holes 225. Additionally, only one gap 230 is present, defining only two plug-retaining sections 235A, 235B. It is noted that a block device preferably has at least two plug-retaining sections, but may have many more as needed. In one embodiment, each plug-retaining section is at least partially separated from an adjacent plug-retaining section by a gap, although a gap between each and every plug-retaining section is not required in all embodiments.

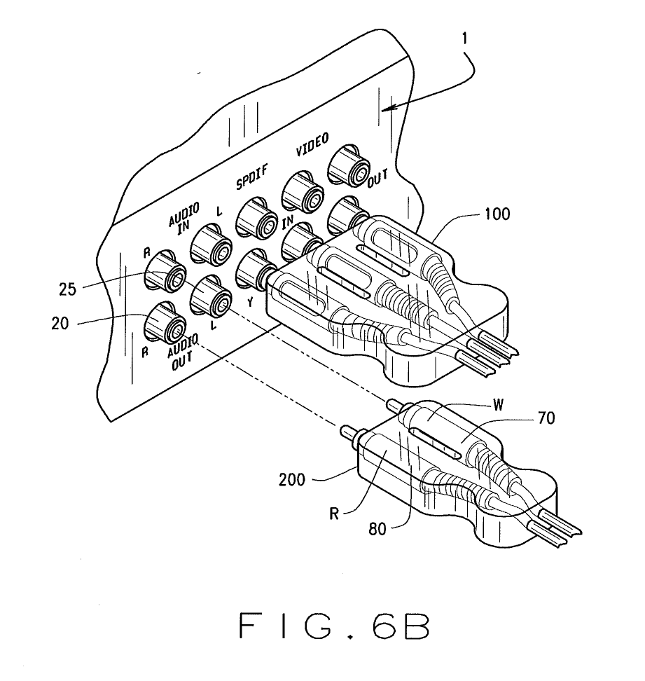

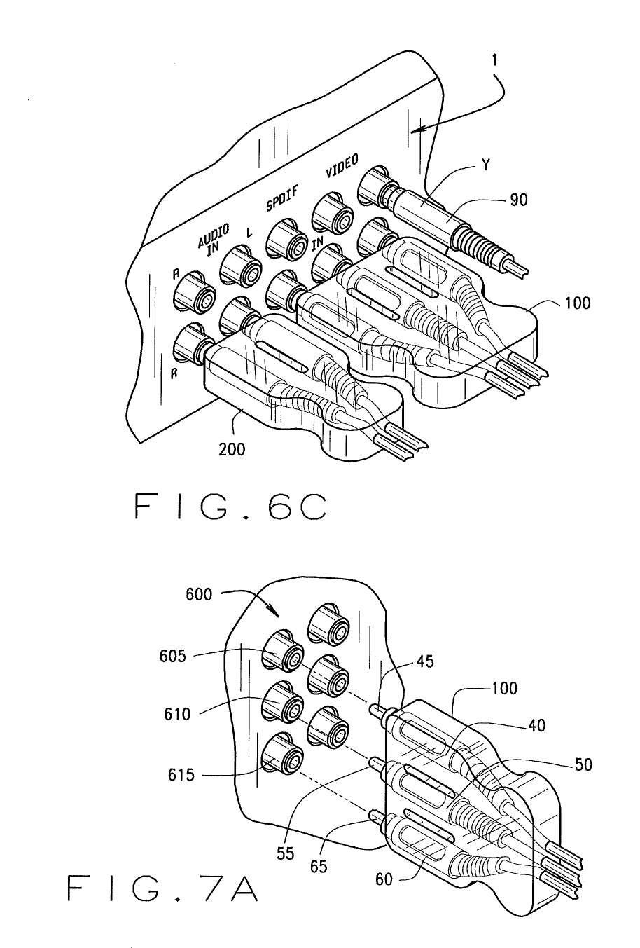

In operation, as shown in FIGS. 6A-6C, three plugs 40, 50, 60 within a block device 100 are aligned with the three corresponding ports 5, 10, 15 on an electronic device 1. As the block device 100 holds the three plugs 40, 50, 60 in place, the user needs much less time and effort to plug in all three at once. Further, indentations 140 help the user to grip the block device 100 and plug in the plugs 40, 50, 60. FIG. 6B shows the three plugs 40, 50, 60 in block device 100 already plugged in, with block device 200 and plugs 70, 80 therein ready for insertion into corresponding ports 20, 25. FIG. 6C illustrates both block devices 100, 200 plugged into the electronic device 1, along with yellow RCA plug 90.

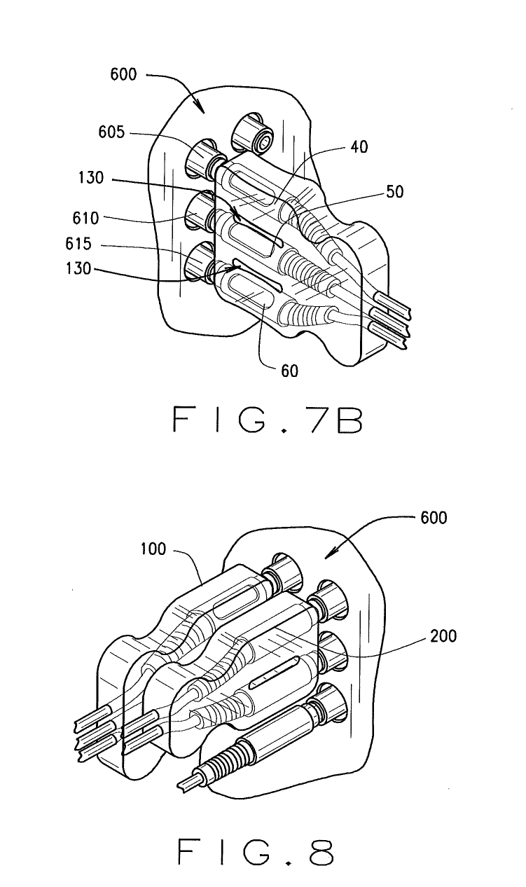

However, it is recognized that not all electronic devices have the same orientation of ports, or even the same spacing between ports. For example, FIG. 7A illustrates ports Component Video ports 605, 610, 615 arranged vertically on a different electronic device 600. Further, as shown, pin and ring connector portions 45, 55, 65 when retained in block device 100 do not exactly align with the ports 605, 610, 615. As can be seen, when pin and ring connector portion 45 of RCA plug 40 is aligned with port 605, the other two pin and ring connector portions 55, 65 of RCA plugs 50, 60 do not align with ports 610 and 615, respectively.

As noted above, body portion 105, 205 is preferably comprised of a material which is flexible, and which deforms substantially elastically. Thus, body portion 105, 205 itself allows for some level of adjustment of the position of plugs 40, 50, 60, 70, 80. Further, gaps 130, 230 preferably further assist in allowing for proper alignment of plugs with ports, even where the distance between ports is not consistent. As can be seen in FIG. 7B in which plugs 40, 50, 60 in block device 100 have been successfully plugged into ports 605, 610, 615, the gaps 130 have narrowed somewhat so allow the plugs 40, 50, 60 to reside closer together than they normally would. Preferably, the flexibility of the body portion 105, 205 and/or gaps 130, 230 allow for approximately 1-2 millimeters of adjustment of a plug with respect to an adjacent plug, although more or less adjustment is envisioned. However, as noted above, gaps 130, 230 may actually extend all the way to the plug end 115 of body portion 105. In such an embodiment, even greater flexibility would be afforded in the positioning of the plugs 40, 50, 60, 70, 80.

FIG. 8 shows all six RCA cables plugged into device 600. The time necessary for accomplishing this is at least about half the time that would have been needed ordinarily. The six plugs were inserted with only three actual plugging-in motions by the user. Further time reduction may be realized by virtue of lessening the time needed for the operator to figure out which plugs need to be plugged into which ports, and in what order

In a different embodiment, the body portion may be relatively rigid. In such an embodiment, in order to allow for varying distances between ports, the plug-retaining sections preferably loosely retain the various plugs. As above, preferably 1-2 millimeters of adjustment of the plugs within the plug-retaining sections is provided for in such an embodiment. Further, in any embodiment, the body portion may be overmolded around the plugs permanently, or may be structured such that plugs can be inserted and removed from the plug-retaining sections as desired. Further, the body portion, plug-retaining sections, plug holes, etc. may all be sized and structured to retain other types of cables and plugs, such as HDMI cables, fiber optic cables standard audio cables and any other type of cable as would be recognized.

Thus, there has been shown and described an embodiment of a novel multi-connector block device. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A multi-connector block device for use with at least two A/V cables, the device comprising:
a body portion including a cable end and a plug end, said cable end having at least one cable hole therein and said plug end having at least two plug holes therein, and wherein said body portion includes a hollow extending from said at least one cable hole to said at least two plug holes;
at least two plug-retaining sections formed by the hollow, said plug-retaining sections each being sized and shaped to retain an A/V cable plug such that a connector prong of the plug extends from the corresponding plug hole of the body;
wherein a cable connected to said A/V cable plug extends back through the hollow and out the at least one cable hole of the body portion when an A/V cable plug is housed within the plug-retaining section.

2. The multi-connector block device of claim 1 wherein the body portion is comprised of material which is flexible and deforms substantially elastically.

3. The multi-connector block device of claim 2 wherein the material is one of urethane rubber and silicone rubber.

4. The multi-connector block device of claim 2 wherein the material has a hardness of between 40 and 80 Shore A.

5. The multi-connector block device of claim 2 wherein the material has a hardness of between 60 and 80 Shore A.

6. The multi-connector block device of claim 1 wherein the body portion is sufficiently flexible to allow an A/V cable plug to be inserted and withdrawn from a plug-retaining section.

7. The multi-connector block device of claim 1 wherein, toward the plug end of the body portion, material of the body portion isolates each plug-retaining section from an adjacent plug-retaining section.

8. The multi-connector block device of claim 7 wherein a gap is present through the material of the body portion between adjacent plug-retaining sections, so as to provide increased flexibility of the body portion between the plug-retaining sections and allow A/V cable plugs housed within the respective plug-retaining sections to deflect laterally by at least about 1 to 2-mm.

9. The multi-connector block device of claim 8 wherein said gap extends all the way to the plug end of the body portion for additional deflection.

10. The multi-connector block device of claim 1, wherein the body portion is comprised of material which is relatively rigid.

11. The multi-connector block device of claim 10 wherein said at least one said plug-retaining section is sized and shaped to retain an A/V cable plug loosely, such that said A/V cable plug to move laterally within the plug-retaining section by about 1 to 2-mm.

12. The multi-connector block device of claim 1 wherein the body portion includes at least one indentation toward the cable end of the body portion.

13. The multi-connector block device of claim 1 wherein the body portion is over-molded around the A/V cable plugs to secure same permanently within the body portion.

14. The multi-connector block device of claim 1 wherein the body portion is substantially transparent.

15. A multi-connector block device for use with at least two A/V cables, the device comprising:
a body including:
at least two channels, each channel for retaining an A/V cable plug therein;
a gap in the body positioned between two adjacent channels;
a plug hole sized and positioned to allow a plug connector portion to extend therethrough.
